(19) United States
(12) Patent Application Publication
(10) Pub. No.: US 2003/0168529 A1
(43) Pub. Date: Sep. 11, 2003

(54) Fuel injection valve

(76) Inventors: Fevzi Yildrim, Gerlingen (DE); Guenther Hohl, Stuttgart (DE); Michael Huebel, Gerlingen (DE); Norbert Keim, Loechgau (DE)

Correspondence Address: KENYON & KENYON, ONE BROADWAY, NEW YORK, NY, 10004, US

(21) Appl. No.: 10/204,112

(22) PCT Filed: Dec. 15, 2001
(86) PCT No.: PCT/DE01/04750

(30) Foreign Application Priority Data
Dec. 19, 2000 (DE) 100 63 258.0

(51) Int. Cl. B05B 1/30

(52) U.S. Cl. 239/585.1

(57) ABSTRACT

A fuel injector (1), in particular for the direct injection of fuel into the combustion chamber of a mixture-compressing, spark-ignited internal combustion engine includes an actuator (10), a valve needle (3) actuatable by the actuator (10) for operating a valve-closure member (4), which, together with a valve-seat surface (6) forms a sealing seat and a swirl disk (35) having at least one swirl channel (36). An elastic fuel metering ring (37) is situated in a recess (43) of a nozzle body (2) of the fuel injector (1) in such a manner that a metering cross-section of the at least one swirl channel (36) is variable as a function of a fuel pressure prevailing in the fuel injector (1) during operation.

### BACKGROUND INFORMATION

The present invention is directed to a fuel injector according to the definition of the species in the main claim.

A fuel injector for the direct injection of fuel into the combustion chamber of a mixture-compressing, spark-ignited internal combustion engine, the fuel injector including a guide and seat area formed by three disk-shaped elements at the downstream end of the fuel injector is known from German Patent Application 197 36 682 A1. A swirl element is embedded between a guide element and a valve seat element. The guide element is used to guide an axially movable valve needle that passes through the guide element while a valve closing section of the valve needle cooperates with a valve-seat surface of the valve seat element. The swirl element has an inner opening area with multiple swirl channels that are not connected to the outer circumference of the swirl element. The entire opening area extends completely across the axial thickness of the swirl element.

A disadvantage of the fuel injectors known from the publication cited above is in particular the fixedly set swirl angle, which cannot be adapted to the different operating states of an internal combustion engine such as partial load and full load operation. As a result, it is also not possible to adapt the cone apex angle of the injected mixture cloud to the various operating states, which results in non-homogeneities during combustion, increased fuel consumption, as well as increased exhaust gas emission.

### ADVANTAGES OF THE INVENTION

In contrast, the advantage of the fuel injector according to the present invention having the characterizing features of the main claim is that it is possible to adjust the swirl as a function of the operating state of the fuel injector, making it possible to produce a jet pattern adapted to the operating state of the fuel injector. This makes it possible to optimize both the mixture formation and the combustion process.

The jet apex angle is advantageously influenced by the pressure of the fuel flowing through the fuel injector which, through an elastic fuel metering ring, produces a variable throttle effect according to the operating state and thus makes it possible to have a direct influence on the swirl intensity.

The measures cited in the dependent claims make advantageous refinements on and improvements of the fuel injector specified in the main claim possible.

A particular advantage in this connection is the simple and cost-effective shape of the fuel metering ring, which may be easily made from an elastic material and inserted without difficulty into standard fuel injectors having conventional swirl formation.

A particular advantage is the flexibility in the choice of the swirl disk since the jet pattern remains formable due to a varied shape and number of swirl channels and nonetheless it may be adapted to the operating state.

A further advantage is that the measure according to the present invention also makes it possible to adjust the steady-state flow through the fuel injector, making it possible to reduce variations in the steady-state flow, which in turn has a positive effect on fuel consumption and exhaust gas values.

### DRAWING

An exemplary embodiment of the invention is depicted in simplified form in the drawing and explained in greater detail in the following description.

FIG. 1 shows an axial section through an exemplary embodiment of a fuel injector according to the present invention.

FIG. 2 shows a schematic section through the spray-discharge end of the fuel injector designed according to the present invention along line II-II in FIG. 1.

FIG. 3 shows a schematic section of area III in FIG. 1.

### DESCRIPTION OF THE EXEMPLARY EMBODIMENT

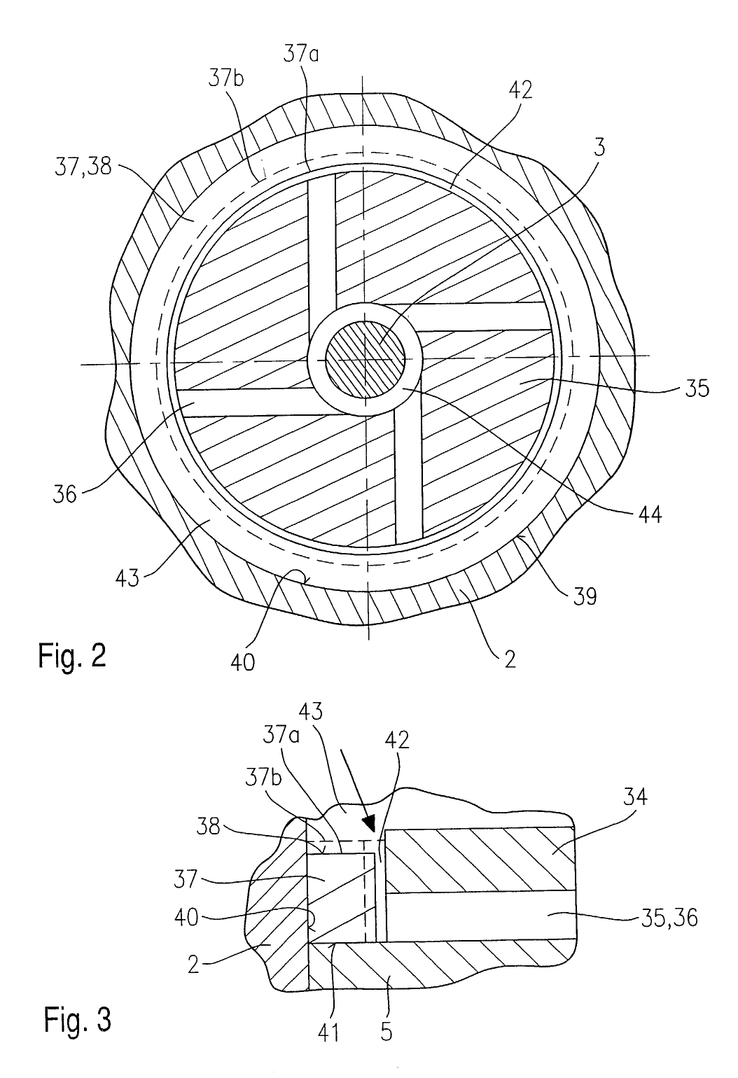

Before an exemplary embodiment of a fuel injector 1 according to the present invention is described in greater detail based on FIGS. 2 and 3, the essential components of fuel injector 1 according to the present invention will be explained briefly in general terms.

Fuel injector 1 is designed in the form of a fuel injector for fuel injection systems of mixture-compressing, spark-ignited internal combustion engines. Fuel injector 1 is suitable in particular for the direct injection of fuel into a combustion chamber (not shown) of an internal combustion engine.

Fuel injector 1 includes a nozzle body 2 in which valve needle 3 is situated. Valve needle 3 is mechanically linked with a valve-closure member 4, which cooperates with a valve-seat surface 6 situated on a valve-seat member 5 to form a sealing seat. In the exemplary embodiment, fuel injector 1 is an inwardly opening fuel injector 1 having at least one spray-discharge orifice 7. Nozzle body 2 is sealed off from outer pole 9 of a magnetic circuit by a seal 8. A solenoid 10 is encapsulated in a coil housing 11 and wound on a coil frame 12 which is in contact with an inner pole 13 of the magnetic circuit. Inner pole 13 and outer pole 9 are separated by a gap 26 and are supported by a connecting component 29. Solenoid 10 is energized by an electric current which may be supplied by an electric plug contact 17 via a line 19. Plug contact 17 is enclosed by a plastic sheathing 18 which may be extruded onto inner pole 13.

Valve needle 3 is guided in a valve needle guide 14 which is designed in the shape of a disk. A matching adjusting disk 15 is used to adjust the lift. An armature 20 is located on the other side of adjusting disk 15. Armature 20 is friction-locked to valve needle 3 via a first flange 21, valve needle 3 being connected to first flange 21 by a weld 22. A restoring spring 23 is supported on first flange 21, which in the present design of fuel injector 1 is pre-stressed by a sleeve 24.

A second flange 31, which is connected to valve needle 3 by a weld 33, is used as a lower armature stop. An elastic intermediate ring 32 which is in contact with second flange 31 prevents rebounding when fuel injector 1 is closed.

A guide disk 34 formed on the inlet side of the sealing seat ensures that valve needle 3 is centered and thus prevents valve needle 3 from tilting and subsequent imprecision of the metered fuel quantity. A swirl disk 35 having swirl channels 36 is situated between guide disk 34 and valve-seat member 5. A fuel metering ring 37 is provided between guide disk 34 and swirl disk 35 on one side and nozzle body 2 on the other side, the fuel metering ring preferably being made of an elastic material and being deformable under the influence of the system pressure prevailing in fuel injector 1. A detailed description of the fuel metering ring may be found in FIGS. 2 and 3.

Fuel channels 30a and 30b run in valve needle guide 14 and in armature 20. The fuel is supplied via a central fuel supply 16 and is filtered through a filter element 25. A seal 28 seals off fuel injector 1 from a fuel line, which is not shown in greater detail.

When fuel injector 1 is in its idle state, restoring spring 23 acts on armature 20 against the direction of its lift so that valve-closure member 4 is held in sealing contact against valve seat 6. When solenoid 10 is energized, it builds up a magnetic field which moves armature 20 in the lift direction against the elastic force of restoring spring 23, the lift being predetermined in the idle state by a working gap 27 located between inner pole 12 and armature 20. Armature 20 entrains flange 21, which is welded to valve needle 3, also in the lift direction. Valve-closure member 4, which is mechanically linked with valve needle 3, lifts from valve-seat surface 6 and the fuel is spray-discharged.

When the coil current is switched off, the pressure of restoring spring 23 causes armature 20 to drop away from inner pole 13 after sufficient decay of the magnetic field, as a result of which flange 21, which is mechanically linked to valve needle 3, moves against the lift direction. This moves valve needle 3 in the same direction, as a result of which valve-closure member 4 settles on valve-seat surface 6 and fuel injector 1 is closed.

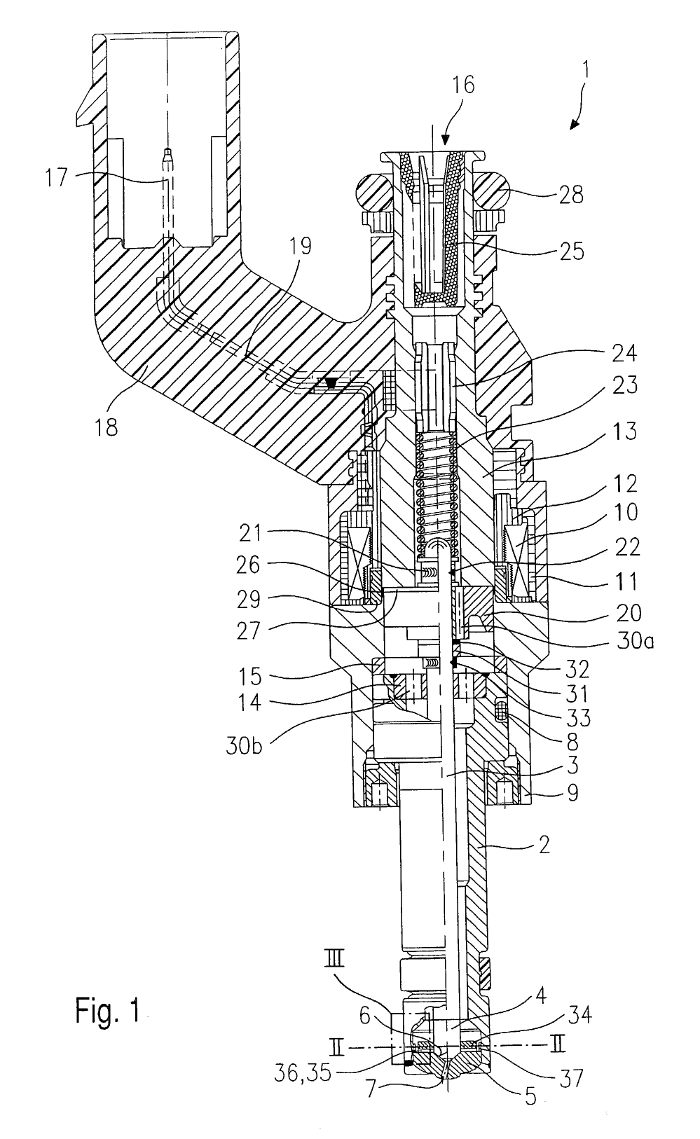

In a partial, schematic illustration, FIG. 2 shows a section along line II-II through the downstream end of fuel injector 1 shown in FIG. 1. Elements already described are provided with matching reference symbols in all figures.

The described section through valve needle 3 and swirl disk 35 shows fuel metering ring 37 already mentioned above in two different operating states of fuel injector 1. Swirl disk 35 is cut in a plane that runs through fuel injector 1 on the inlet side of an inlet-side face 38 of fuel metering ring 37. The number of swirl channels 36 in swirl disk 35 is limited to four in order to make the schematic representation more comprehensible. However, more or fewer swirl channels 36 are also possible.

A swirl chamber 44 is formed between valve needle 3 and swirl disk 35, the swirl chamber preferably being dimensioned in such a manner that the swirl current formed stays homogeneous. The volume of swirl chamber 44 should be great enough to avoid undesirable throttle effects but small enough to minimize the dead volume. This is important in full load operation in particular, so that the stoichiometry of the injected mixture cloud is ensured.

Fuel metering ring 37 is preferably made from an elastic polymer and designed in the shape of a ring. One of its outside surfaces 39 is in contact with an inside wall 40 of nozzle body 2. The fuel metering ring is supported on valve-seat member 5 by a downstream face 41. A gap 42 is formed between fuel metering ring 37 and swirl disk 35, the radial width of gap 42 being changeable as a function of the fuel pressure during the operation of fuel injector 1 due to the elasticity of fuel metering ring 37.

In the partial load range of fuel injector 1, the pressure of the fuel flowing through fuel injector 1 is such that there is an equilibrium of forces which acts upon fuel metering ring 37 uniformly in the radial and axial direction. Gap 42 then has its smallest radial extension. As a result, the fuel flow is also minimal, which results in only a slight swirl of the fuel flowing comparatively slowly through swirl channels 36. As a consequence, a mixture cloud injected into the combustion chamber of the internal combustion engine has only a slight widening, i.e., a small jet apex angle. This corresponds to the requirements for the mixture cloud during partial load operation.

If the fuel pressure is increased corresponding to full load operation of fuel injector 1, fuel metering ring 37 is deformed due to a shift in the force condition acting in the radial and axial direction, the deformation causing the axial dimension of fuel metering ring 37 to increase and its radial dimension to decrease. Correspondingly, gap 42 between fuel metering ring 37 and swirl disk 35 expands so that the throttle effect of gap 42 decreases. As a consequence, the quantity as well as the velocity of fuel flowing through swirl channels 36 increases, as a result of which the swirl is also intensified. This results in a widening of the mixture cloud injected into the combustion chamber, the mixture cloud thus having a wider jet apex angle and homogeneously filling the combustion chamber.

The different states of elastic fuel metering ring 37 are shown in FIG. 2, each by a separate line. The line identified as 37a indicates the initial state with a uniform load on fuel metering ring 37 in the axial and radial directions while broken line 37b shows the state of maximum pressure and accordingly the maximum radial width of gap 42.

In a partial sectional illustration, FIG. 3 shows a section of fuel injector 1 according to the present invention shown in FIG. 1 in area III of FIG. 1.

For the sake of clarity, swirl disk 35 was cut in the region of swirl channel 36. The arrow denotes the inflow direction of the fuel. The unloaded state of fuel metering ring 37 is again identified as 37a; the state of maximum pressure load is identified as 37b.

FIG. 3 makes it clear that the radial width of gap 42 directly determines the metering cross-section for the quantity of fuel flowing through. Consequently, the flow velocity of the fuel may be varied according to the continuity equation, as a result of which there is a possibility of direct intervention to adapt the swirl intensity to the operating state of fuel injector 1.

In the partial load range, it is not the homogeneous distribution of the fuel in the combustion chamber that is of primary importance but rather the penetration depth; therefore, even a slow swirl flow with possible non-homogeneities, caused by the dead volume of swirl chamber 44, does not adversely affect the combustion operation, while in full load operation, the swirl flow has a high degree of homogeneity and it is thus possible to optimize the stoichiometry of the mixture cloud.

The present invention is not limited to the exemplary embodiments shown and in particular, it may also be used with fuel injectors 1 having piezoelectric or magnetostrictive actuators 10 and with any design variants of fuel injectors 1.

What is claimed is:

1. A fuel injector (1), in particular for the direct injection of fuel into a combustion chamber of a mixture-compressing, spark-ignited internal combustion engine, comprising an actuator (10), a valve needle (3) actuatable by the actuator (10) for operating a valve-closure member (4), which, together with a valve-seat surface (6) forms a sealing seat, and a swirl disk (35) having at least one swirl channel (36), wherein an elastic fuel metering ring (37) is arranged in such a way that a metering cross-section of the at least one swirl channel (36) is variable as a function of a fuel pressure prevailing in the fuel injector (1) during operation.

2. The fuel injector as recited in claim 1, wherein an outside surface (39) of the fuel metering ring (37) is in contact with an inside wall (40) of a nozzle body (2) of the fuel injector (1).

3. The fuel injector as recited in one of claims 1 or 2, wherein a downstream face (41) of the fuel metering ring (37) is supported on a valve-seat member (5) of the fuel injector (1).

4. The fuel injector as recited in one of claims 1 through 3, wherein a guide disk (34) for the valve needle (3) is situated on the inlet side of the swirl disk (35) and is connected with it.

5. The fuel injector as recited in claim 4, wherein the fuel metering ring (37) radially surrounds the outside of the swirl disk (35) and the guide disk (34).

6. The fuel injector as recited in claim 5, wherein a gap (42) is formed between the fuel metering ring (37) and the swirl disk (35).

7. The fuel injector as recited in claim 6, wherein the quantity of fuel flowing through the at least one swirl channel (36) is proportional to the radial width of the gap (42).

8. The fuel injector as recited in claim 6 or 7, wherein the area of an inlet-side face (38) of the fuel metering ring (37) is dimensioned relative to an area enclosed by the fuel metering ring (37) in such a manner that the radial width of the gap (42) increases when the fuel pressure is increased.

9. The fuel injector as recited in one of claims 1 through 8, wherein the swirl generated by the at least one swirl channel (36) is proportional to the rate of flow of the fuel.

10. The fuel injector as recited in claim 9, wherein a jet apex angle of a mixture cloud injected into the combustion chamber is proportional to the fuel pressure.

11. The fuel injector as recited in one of claims 4 through 8, wherein the swirl disk (35) and the guide disk (34) are formed of one piece.
